(19) United States
(12) Patent Application Publication
(10) Pub. No.: US 2018/0223748 A1
(43) Pub. Date: Aug. 9, 2018

(54) SYSTEM AND METHOD FOR ENGINE CONTROL

(71) Applicant: GENERAL ELECTRIC COMPANY, Schenectady, NY (US)

(72) Inventors: Chetan S. TULAPURKAR, Bangalore (IN); Prashant SRINIVASAN, Bangalore (IN); Josef THALHAUSER, Nussdorf, Bayern (DE); Peter SCHAEFFERT, Jenbach, Tirol (AT); Juergen LANG, Jenbach, Tirol (AT)

(21) Appl. No.: 15/749,627

(22) PCT Filed: Aug. 6, 2015
(86) PCT No.: PCT/US15/44043

§ 371 Date: Feb. 1, 2018

(51) Int. Cl. F02D 35/02; F02D 13/02; F02D 19/02; F02D 29/06; F02D 41/00; F02P 5/152

(52) U.S. Cl. CPC F02D 35/027; F02D 13/0234; F02D 13/0269; F02D 19/023; F02D 29/06; F02D 41/0007; F02M 21/0215; F02D 2041/001; F02D 2041/002; F02D 2200/0406; F02D 2200/1002; F02D 2200/60; F02P 5/1521

(57) ABSTRACT

The subject matter disclosed herein relates to a system and method for engine control. In particular, a system, may utilize a variable valve timing device, modify a variable valve timing profile, monitor engine performance, and adjust operating parameters of the engine accordingly. Such a system, may enhance the response time of an engine during transient operation.

### TECHNOLOGY FIELD

The subject matter disclosed herein relates to a system and method for engine control. Specifically, the present disclosure relates to a system that modifies a variable valve timing profile and adjusts a valve of a gas powered engine during transient engine operation.

### BACKGROUND

Combustion engines typically combust a carbonaceous fuel, such as natural gas, gasoline, diesel, and the like, and use the corresponding expansion of high temperature and pressure gases to apply a force to certain components of the engine (e.g., piston disposed in a cylinder) to move the components over a distance. Each cylinder may include one or more valves that open and close in conjunction with combustion of the carbonaceous fuel. For example, an intake valve may direct an oxidant such as air, or a mixture of air and fuel, into the cylinder. A fuel mixes with the oxidant and combusts (e.g., ignition via a spark) to generate combustion fluids (e.g., hot gases), which then exit the cylinder via an exhaust valve.

Combustion engines may power a load, however, the power demands of a load may not be constant. Therefore, operating parameters of the engine may be adjusted to meet a new load demand. For example, an intake valve may be left open for a specific period of time based on the power demanded. The timing of the intake valve closure may be adjusted via a variable valve timing (“VVT”) profile (e.g., a timing profile controlling when the variable valve opens and closes). However, the VVT profile may be pre-determined and thus may not take into account all operating parameters that affect engine performance.

### BRIEF DESCRIPTION

In one embodiment, a system for controlling transient operations of an engine includes a controller configured to receive a first signal corresponding to a load setpoint of the engine, determine a boost pressure setpoint based at least on the first signal, receive a second signal corresponding to an actual boost pressure in the engine, compare the second signal to the boost pressure setpoint, actuate or modify one or more of a bypass valve, a wastegate valve, and a variable valve timing (“VVT”) profile when the second signal is greater than or equal to a threshold boost pressure value, and actuate a throttle valve when the second signal is less than the threshold boost pressure value.

In another embodiment, a system for controlling transient operations of an engine includes a controller configured to receive a first signal corresponding to an engine power setpoint of the engine, receive a second signal corresponding to an actual engine power of the engine, determine an ignition timing and a position of a variable valve timing (“VVT”) device based at least on the second signal, receive a third signal from a knock sensor, compare the first signal to the second signal, and modify one or more of a VVT profile and an ignition timing map when the first signal is greater than the second signal and when the third signal indicates an engine knock event.

In still another embodiment, a system for controlling transient operations of an engine includes a sensor configured to monitor an engine demand, an actuator coupled to one or more valves, and a controller configured to receive a signal from the sensor corresponding to the engine demand, determine an operational profile of the one or more valves based on the signal, an operational condition, and an operational constraint, and to send a signal to the actuator to adjust the one or more valves according to the operational profile to satisfy the operational condition and the operational constraint.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 illustrates a block diagram of a portion of an engine driven power generation system having a reciprocating internal combustion engine, in accordance with aspects of the present disclosure;

FIG. 2 illustrates a cross-sectional side view of a piston-cylinder assembly having a piston disposed within a cylinder of the reciprocating engine of FIG. 1, in accordance with aspects of the present disclosure;

FIG. 3 illustrates an engine assembly that may use a VVT device in combination with another engine control module, in accordance with aspects of the present disclosure;

FIG. 4 illustrates a process flow for monitoring and modifying a boost pressure in the engine assembly of FIG. 3, in accordance with aspects of the present disclosure;

FIG. 5 illustrates a block diagram of a power supply system that may employ the process described in FIG. 4, in accordance with aspects of the present disclosure;

FIG. 6 illustrates a process flow for monitoring an engine power demand and adjusting engine parameters based at least on the power demand and a knock signal, in accordance with aspects of the present disclosure;

FIG. 7 illustrates a block diagram of another embodiment of a power supply system that may use the process described in FIG. 6, in accordance with aspects of the present disclosure; and

FIG. 8 illustrates an implementation of an optimization module along with inputs and outputs, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any numerical examples in the following discussion are intended to be non-limiting, and thus additional numerical values, ranges, and percentages are within the scope of the disclosed embodiments. Furthermore, it should also be understood that terms such as “top,” “above,” “over,” “on,” and the like are words of convenience and are not to be construed as limiting terms. In addition, like reference characters designate like or corresponding parts throughout the several views shown in the figures.

Gas engines may generally undergo a combustion process to power a load. Some gas engines utilize the Miller Cycle to enhance engine operation. During the Miller Cycle, the intake valve of an engine may be left open for a shorter time than a normal combustion cycle (e.g., Otto Cycle), which may enable a pressure and temperature drop in the engine cylinder. Accordingly, a supercharger (e.g., a turbocharger) may be used to compensate for the potential loss in pressure resulting from the intake valve closing before the piston reaches bottom dead center. Further, when the engine undergoes an increase in load (e.g., ramp up, load rejection, or another form of transient operation), the timing at which the intake valve closes may be changed by utilizing an intake valve with variable valve timing (“VVT”). The amount of pressure (e.g., boost pressure) supplied to a cylinder from the supercharger may depend on the timing at which the intake valve closes. While utilizing the Miller Cycle and employing a supercharger and VVT in the engine may enable more efficient operation, VVT profiles (e.g., timing maps that direct the intake valve to close at a given time) may be pre-determined and thus may not take into account all operating parameters affecting engine performance. Therefore, it may be desirable to utilize VVT with other engine modules (e.g., boost control, fuel control, ignition control, knock control) that monitor engine performance and control operating conditions of the engine accordingly. Such a system may enhance the response time of an engine during transient operation.

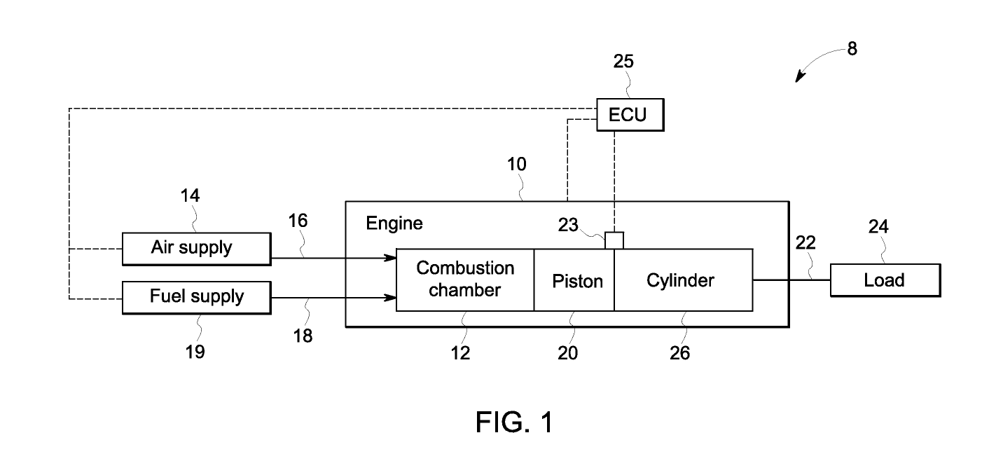

Turning to the drawings, FIG. 1 illustrates a block diagram of an embodiment of a portion of an engine driven power generation system having a reciprocating internal combustion engine. As described in detail below, the system 8 includes an engine 10 (e.g., a reciprocating internal combustion engine) having one or more combustion chambers 12 (e.g., 1, 2, 3, 4, 5, 6, 7, 8, 10, 12, 14, 16, 18, 20, 24, or more combustion chambers 12). An oxidant supply 14 (e.g., an air supply) is configured to provide a pressurized oxidant 16, such as air, oxygen, oxygen-enriched air, oxygen-reduced air, or any combination thereof, to each combustion chamber 12. The combustion chamber 12 is also configured to receive a fuel 18 (e.g., a liquid and/or gaseous fuel) from a fuel supply 19, and a fuel-air mixture ignites and combusts within each combustion chamber 12. The hot pressurized combustion gases cause a piston 20 adjacent to each combustion chamber 12 to move linearly within a cylinder 26 and convert pressure exerted by the gases into a rotating motion, which causes a shaft 22 to rotate. Further, the shaft 22 may be coupled to a load 24, which is powered via rotation of the shaft 22. For example, the load 24 may be any suitable device that may generate power via the rotational output of the system 10, such as an electrical generator. Additionally, although the following discussion refers to air as the oxidant 16, any suitable oxidant may be used with the disclosed embodiments. Similarly, the fuel 18 may be any suitable gaseous fuel, such as natural gas, associated petroleum gas, propane, biogas, sewage gas, landfill gas, coal mine gas, for example. The fuel 18 may also include a variety of liquid fuels, such as gasoline or diesel fuel.

The system 8 disclosed herein may be adapted for use in stationary applications (e.g., in industrial power generating engines) or in mobile applications (e.g., in cars or aircraft). The engine 10 may be a two-stroke engine, three-stroke engine, four-stroke engine, five-stroke engine, or six-stroke engine. The engine 10 may also include any number of combustion chambers 12, pistons 20, and associated cylinders 26 (e.g., 1-24). For example, in certain embodiments, the system 8 may include a large-scale industrial reciprocating engine having 4, 6, 8, 10, 12, 16, 24 or more pistons 20 reciprocating in cylinders 26. In some such cases, the cylinders 26 and/or the pistons 20 may have a diameter of between approximately 13.5-34 centimeters (cm). In some embodiments, the cylinders 26 and/or the pistons 20 may have a diameter of between approximately 10-40 cm, 15-25 cm, or about 15 cm. The system 8 may generate power ranging from 10 kW to 10 MW. In some embodiments, the engine 10 may operate at less than approximately 1800 revolutions per minute (RPM). In some embodiments, the engine 10 may operate at less than approximately 2000 RPM, 1900 RPM, 1700 RPM, 1600 RPM, 1500 RPM, 1400 RPM, 1300 RPM, 1200 RPM, 1000 RPM, 900 RPM, or 750 RPM. In some embodiments, the engine 10 may operate between approximately 750-2000 RPM, 900-1800 RPM, or 1000-1600 RPM. In some embodiments, the engine 10 may operate at approximately 1800 RPM, 1500 RPM, 1200 RPM, 1000 RPM, or 900 RPM. Exemplary engines 10 may include General Electric Company's Jenbacher Engines (e.g., Jenbacher Type 2, Type 3, Type 4, Type 6 or J920 FleXtra) or Waukesha Engines (e.g., Waukesha VGF, VHP, APG, 275GL), for example.

The driven power generation system 8 may include one or more knock sensors 23 suitable for detecting engine “knock.” The knock sensor 23 may sense vibrations, acoustics, or sound caused by combustion in the engine 10, such as vibrations, acoustics, or sound due to detonation, pre-ignition, and/or pinging. Therefore, the knock sensor 23 may include an acoustic or sound sensor, a vibration sensor, or a combination thereof. For example, the knock sensor 23 may include a piezoelectric vibration sensor. The knock sensor 23 may monitor acoustics and/or vibration associated with combustion in the engine 10 to detect a knock condition, e.g., combustion at an unexpected time not during a normal window of time for combustion. The knock sensor 23 is shown communicatively coupled to a control system or controller 25, such as an engine control unit (ECU) 25. During operations, signals from the knock sensor 23 are communicated to the ECU 25. The ECU 25 may then manipulate the signals that the ECU 25 receives and adjust certain engine 10 parameters accordingly. For example, the ECU 25 may adjust ignition timing, a position of one or more valves disposed in the engine 10, and/or a VVT profile to enhance engine performance.

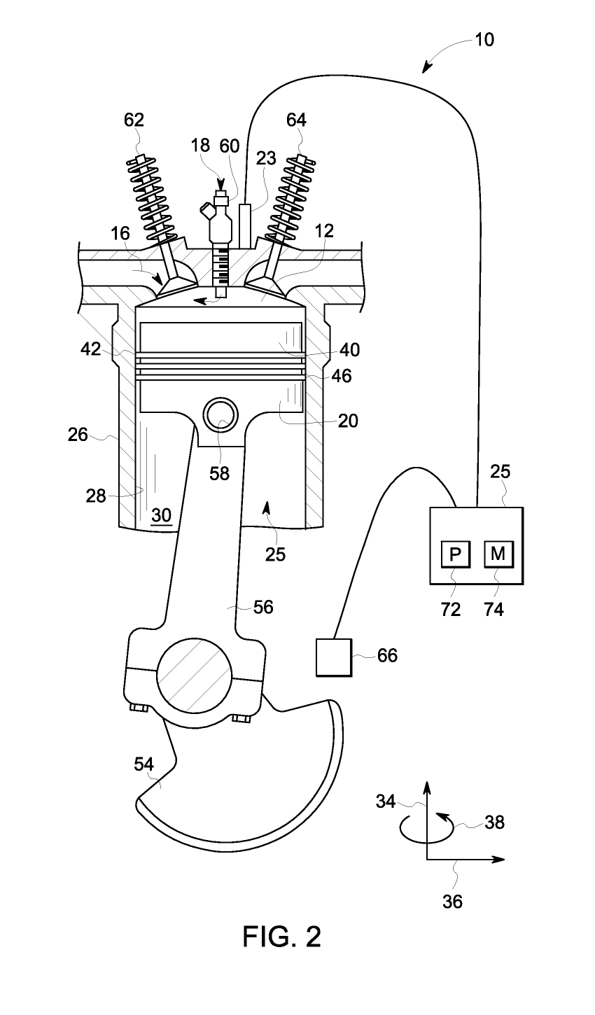

FIG. 2 is a cross-sectional side view of an embodiment of a piston-cylinder assembly having a piston 20 disposed within a cylinder 26 (e.g., an engine cylinder) of the reciprocating engine 10. The cylinder 26 has an inner annular wall 28 defining a cylindrical cavity 30 (e.g., bore). The piston 20 may be defined by an axial axis or direction 34, a radial axis or direction 36, and a circumferential axis or direction 38. The piston 20 includes a top portion 40 (e.g., a top land). The top portion 40 generally blocks the fuel 18 and the air 16, or a fuel-air mixture 32, from escaping from the combustion chamber 12 during reciprocating motion of the piston 20.

As shown, the piston 20 is attached to a crankshaft 54 via a connecting rod 56 and a pin 58. The crankshaft 54 translates the reciprocating linear motion of the piston 24 into a rotating motion. As the piston 20 moves, the crankshaft 54 rotates to power the load 24 (shown in FIG. 1), as discussed above. As shown, the combustion chamber 12 is positioned adjacent to the top land 40 of the piston 20. A fuel injector 60 may provide the fuel 18 to the combustion chamber 12, and an intake valve 62 controls the delivery of oxidant (e.g., air 16) to the combustion chamber 12. An exhaust valve 64 controls discharge of exhaust from the engine 10. However, it should be understood that any suitable elements and/or techniques for providing fuel 18 and air 16 to the combustion chamber 12 and/or for discharging exhaust may be utilized, and in some embodiments, no fuel injection is used. In operation, combustion of the fuel 18 with the oxidant 16 in the combustion chamber 12 may cause the piston 20 to move in a reciprocating manner (e.g., back and forth) in the axial direction 34 within the cavity 30 of the cylinder 26.

During operations, when the piston 20 is at the highest point in the cylinder 26 it is in a position called top dead center (TDC). When the piston 20 is at its lowest point in the cylinder 26, it is in a position called bottom dead center (BDC). As the piston 20 moves from TDC to BDC or from BDC to TDC, the crankshaft 54 rotates one half of a revolution. Each movement of the piston 20 from TDC to BDC or from BDC to TDC is called a stroke, and engine 10 embodiments may include two-stroke engines, three-stroke engines, four-stroke engines, five-stroke engines, six-stroke engines, or more.

During engine 10 operations, a sequence including an intake process, a compression process, a power process, and an exhaust process typically occurs. The intake process enables a combustible mixture, such as fuel 18 and oxidant 16 (e.g., air), to be pulled into the cylinder 26, thus the intake valve 62 is open and the exhaust valve 64 is closed. The compression process compresses the combustible mixture into a smaller space, so both the intake valve 62 and the exhaust valve 64 are closed when the engine operates under normal conditions (e.g., the Otto Cycle). In certain embodiments, the intake valve 62 may remain open for a portion of the compression process (e.g., the Miller Cycle). The power process ignites the compressed fuel-air mixture, which may include a spark ignition through a spark plug system, and/or a compression ignition through compression heat. The resulting pressure from combustion then forces the piston 20 to BDC. The exhaust process typically returns the piston 20 to TDC, while keeping the exhaust valve 64 open. The exhaust process thus expels the spent fuel-air mixture through the exhaust valve 64. It is to be noted that more than one intake valve 62 and exhaust valve 64 may be used per cylinder 26.

During the compression process of engine operation, a certain timing of the closure of the intake valve 62 may enable the engine to operate at an optimal efficiency. For example, the engine 10 may open and close the intake valve 62 in accordance with the Miller Cycle. The Miller Cycle may leave the intake valve 62 open for a shorter period of time than a traditional compression process (e.g., the Otto Cycle) such that the intake valve 62 closes before the piston 20 reaches BDC. In such cases, the engine may include a supercharger (e.g., a turbine or a compressor) that applies an additional boost pressure to the cylinder 26 to compensate for the pressure drop in the cylinder 26 that results from the intake valve 62 closing before the piston 20 reaches BDC. In addition to leaving the intake valve 62 open for a shorter period of time than normal (e.g., utilizing the Miller Cycle), the timing of the intake valve 62 closure may be varied based on an operating parameter of the engine to further enhance performance. For example, when the engine 10 experiences an increase in load, it may be desirable for the intake valve 62 to close normally (e.g., a timing based on the Otto Cycle) as the engine 10 begins to ramp-up so that more oxidant 16 and fuel 18 may enter the cylinder, thereby creating an increased combustion force. Conversely, when the engine 10 reaches a higher load (e.g., a threshold load value), it may be desirable for the intake valve 62 to close earlier than normal so that the temperature in the cylinder 26 may be reduced (e.g., the Miller effect) and engine knocking may be prevented.

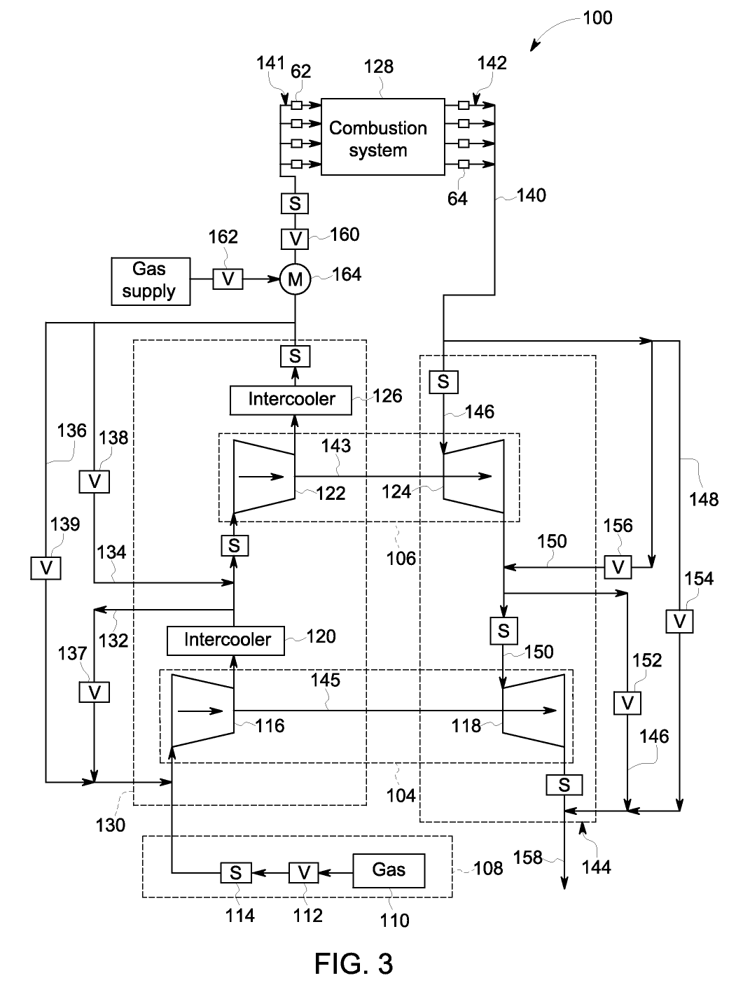

In certain embodiments, the intake valve 62 may include a VVT device that enables the timing of the intake valve 62 closure to vary over the course of engine operation. While varying the timing of the intake valve 62 closure may increase the efficiency of the engine or avoid engine knock, VVT profiles may be pre-determined, and therefore, fail to take into consideration other operating parameters of the engine 10. As such, the ECU 25, or other computing device, may utilize VVT as well as adjust other valves (e.g., throttle valve, wastegate valve, bypass valves, or the like) in the engine 10 to optimize efficiency. Such a system will be described in more detail herein with reference to FIGS. 3-8.

Further, the depicted engine 10 may include a crankshaft sensor 66, the knock sensor 23, and the ECU 25, which includes a processor 72 and memory unit 74. The crankshaft sensor 66 senses the position and/or rotational speed of the crankshaft 54. Accordingly, a crank angle or crank timing information may be derived from the crankshaft sensor 66. That is, when monitoring combustion engines, timing is frequently expressed in terms of crankshaft angle. For example, a full cycle of a four stroke engine 10 may be measured as a 720° cycle. The knock sensor 23 may be a piezoelectric accelerometer, a microelectromechanical system (MEMS) sensor, a Hall effect sensor, a magnetostrictive sensor, and/or any other sensor designed to sense vibration, acceleration, acoustics, sound, and/or movement. In other embodiments, the sensor 23 may not be a knock sensor, but any sensor that may sense vibration, pressure, acceleration, deflection, or movement.

Because of the percussive nature of the engine 10, the knock sensor 23 may be capable of detecting signatures even when mounted on the exterior of the cylinder 26. However, the knock sensor 23 may be disposed at various locations in or about the cylinder 26. Additionally, in some embodiments, a single knock sensor 23 may be shared, for example, with one or more adjacent cylinders 26. In other embodiments, each cylinder may include one or more knock sensors 23. The crankshaft sensor 66 and the knock sensor 23 are shown in electronic communication with the ECU (e.g., a controller) 25. The ECU 25 executes non-transitory code or instructions stored in or accessed from a machine-readable medium (e.g., the memory unit 74) and used by a processor (e.g., the processor 72) to implement the techniques disclosed herein. The memory may store computer instructions that may be executed by the processor 72. Additionally, the memory may store look-up tables and/or other relevant data. The ECU 25 monitors and controls the operation of the engine 10, for example, by adjusting ignition timing, timing of opening/closing valves 62 and 64, adjusting the delivery of fuel and oxidant (e.g., air), and so on.

In certain embodiments, other sensors may also be included in the system 8 and coupled to the ECU 25. For example, the sensors may include atmospheric and engine sensors, such as pressure sensors, temperature sensors, speed sensors, and so forth. For example, the sensors may include knock sensors, crankshaft sensors, oxygen or lambda sensors, engine air intake temperature sensors, engine air intake pressure sensors, jacket water temperature sensors, engine exhaust temperature sensors, engine exhaust pressure sensors, and exhaust gas composition sensors. Other sensors may also include compressor inlet and outlet sensors for temperature and pressure.

FIG. 3 illustrates an embodiment of an engine assembly 100 that may operate using the Miller Cycle and a VVT intake valve, as described above. As illustrated, the engine assembly 100 includes two superchargers 104 and 106. It should be understood, that the engine assembly 100 may include a single supercharger, or the engine assembly 100 may include more than two superchargers (e.g., 3, 4, 5, 6, 7, 8, 9, 10, or more superchargers). Additionally, the engine assembly 100 has a gas supply system 108. The gas supply system 108 may be configured to supply a gas 110 (e.g., the oxidant 16, the fuel 18, or a mixture of the oxidant 16 and the fuel 18) to the engine assembly 100. In certain embodiments, the gas supply system 108 may include a valve 112 and a sensor 114 for controlling and/or monitoring the flow of gas 110 into the engine assembly 100. For example, the sensor 114 may be a flow rate sensor, a temperature sensor, a pressure sensor, a humidity sensor, or the like. In other embodiments, however, the gas supply system 108 may supply just the oxidant 16. Accordingly the fuel 18 may be mixed with the oxidant 16 upstream of the first supercharger 104. In still further embodiments, the fuel 18 may be mixed with the oxidant downstream of the second supercharger 106 (e.g., the fuel 18 and the oxidant 16 exiting the second supercharger 106 may separately be supplied to a mixer).

The supercharger 104 is referred to herein as a low pressure supercharger 104 and the supercharger 106 is referred to herein as a high pressure supercharger 106. The low pressure supercharger 104 includes a low pressure compressor 116 and a low pressure turbine 118. The low pressure compressor 116 may be configured to compress the gas 110 (e.g., the oxidant 16 or a mixture of the fuel 18 and the oxidant 16) from a first pressure to a second pressure. In certain embodiments, the second pressure is greater than the first pressure. However, it should be understood that, upon pressurizing the gas 110 to the second pressure, the gas 110 may increase in temperature (e.g., from a first temperature to a second temperature). Therefore, a first intercooler 120 may be positioned downstream from the low pressure compressor 116, such that the temperature of the gas 110 may be decreased to a desired level (e.g., from the second temperature to the first temperature or from the second temperature to a third temperature).

Similarly, the high pressure supercharger 106 may include a high pressure compressor 122 and a high pressure turbine 124. The high pressure compressor 122 may be configured to compress the gas 110 (e.g., the oxidant 16 or a mixture of the fuel 18 and the oxidant 16) from the second pressure to a third pressure. Upon pressurizing the gas 110 to the third pressure, the gas 110 may again increase in temperature (e.g., from the third temperature to a fourth temperature). Therefore, a second intercooler 126 may be positioned downstream from the high pressure compressor 122, such that the temperature of the gas 110 may be lowered to a desired level (e.g., from the fourth temperature to the third temperature or from the fourth temperature to a fifth temperature) before entering a combustion system 128 of the engine assembly 100.

As shown in the illustrated embodiment, the engine assembly 100 may have the two intercoolers 120 and 126. In other embodiments, the engine assembly 100 may have only one intercooler 126 configured to cool the gas 100 before entering the combustion system 128. In still further embodiments, the engine assembly 100 may include more than two intercoolers (e.g., two intercoolers connected in series downstream from the low pressure compressor 116 and two intercoolers connected in series downstream from the high pressure compressor 122).

In certain embodiments, the gas 110 flows through a first flow path 130, which includes the low pressure supercharger 104 (e.g., via the low pressure compressor 116) and the high pressure supercharger 106 (e.g., via the high pressure compressor 122). When the gas 110 flows through both the low pressure supercharger 104 (e.g., via the low pressure compressor 116) and the high pressure supercharger 106 (e.g., via the high pressure compressor 122), the gas 110 may enter the combustion system 128 at the third pressure. However, the gas 110 may bypass the combustion system 128 and cycle back towards the low pressure supercharger 104, the high pressure supercharger 106, or both via a first bypass valve 137 that may direct the gas 110 towards a second flow path 132, a second bypass valve 138 that may direct the gas 110 towards a third flow path 134, or a third bypass valve 139 that may direct the gas 110 towards a fourth flow path 136. In certain embodiments, the valves 137, 138, and/or 139 may be in either a fully opened position or a fully closed position. In other embodiments, the valves 137, 138, and/or 139 may be in a position between the fully opened position and the fully closed position. Accordingly, when the valve 137 is open, the gas 110 may flow towards the second flow path 132; when the valve 138 is open, the gas 110 may flow towards the third flow path 134; and/or when the valve 139 is open, the gas 110 may flow towards the fourth flow path 136.

In certain embodiments, when the gas 110 flows through the second flow path 132, the gas 110 bypasses the combustion system 128 and the high pressure supercharger 106 and cycles back towards the low pressure supercharger via the first bypass valve 137. Therefore, when the gas 110 flows through the second flow path 132, the gas 110 may re-enter the first flow path 130 downstream (e.g., with respect to the second flow path 132) of the first supercharger 104 at the first pressure. Moreover, adjusting the first bypass valve 137 may enable enhanced control engine power. For example, the more gas 110 that flows through the second flow path 132 (e.g., the more open the first bypass valve 137), the less gas 110 that flows to the combustion system 128. Therefore, increasing a flow of the gas 110 in the second flow path 132 may decrease engine power.

In other embodiments, the gas 110 may flow through the third flow path 134. For example, when the gas 110 flows through the third flow path 134, the gas 110 bypasses the combustion system 128 and flows from a point in the first flow path 130 upstream (e.g., with respect to the third flow path 134) of the high pressure supercharger 106 to a point downstream (e.g., with respect to the third flow path 134) from the high pressure supercharger 106 via a second bypass valve 138. Moreover, adjusting the second bypass valve 138 may enable enhanced control of the engine power. For example, as the second bypass valve 138 is opened wider, more of the gas 110 is diverted back towards the high pressure supercharger 106 rather than entering the combustion system 128, thereby decreasing engine power.

In still further embodiments, the gas 110 may flow through the fourth flow path 136. When the gas 110 flows through the fourth flow path 136, the gas 110 may flow at first through both the low pressure supercharger 104 and the high pressure supercharger 106, but bypass the combustion system 128 via the third bypass valve 139. The gas may then flow to a point in the first flow path 130 downstream (e.g., with respect to the fourth flow path 136) of the low pressure supercharger 104. Moreover, adjusting the third bypass valve 139 may enable enhanced control of the engine power. For example, as the third bypass valve 139 is opened wider, more of the gas 110 is diverted back towards the low pressure supercharger 104, which thereby decreases engine power.

The gas 110 may enters the combustion system 128 via an intake manifold 141. The intake manifold 141 may include one or more intake valves 62, which may be configured to close at a timing specified by a VVT profile. When the intake valve closes 62, the gas 110 may be compressed and combusted (e.g., via a spark plug) causing the piston 20 to drive the crankshaft and power the load. The exhaust valve 64 may then open and allow combustion gases 140 (e.g., carbon dioxide and water) to exit the combustion system 128. The combustion gases 140 may exit the combustion system 128 through an exhaust manifold 142. In certain embodiments, the exhaust manifold 142 includes a plurality of passages that enable the combustion gases 140 to flow out of the combustion system 128 and to the high pressure turbine 124 of the high pressure supercharger 106. The high pressure turbine 124 may be connected to a shaft 143 or another device and configured to power a load (e.g., the high pressure compressor 122) as the combustion gases 140 pass through. Additionally, the combustion gases 140 may flow through the low pressure turbine 118 of the low pressure supercharger 104. In certain embodiments, the low pressure turbine 118 may be connected to a shaft 145 or another device configured to power a load (e.g., the low pressure compressor 116) as the combustion gases 140 pass through.

Similar to the gas 110 entering the combustion system 128, the combustion gases 140 exiting the combustion system 128 may flow through a fifth flow path 144, a sixth flow path 146, a seventh flow path 148, and/or an eighth flow path 150. When the combustion gas 140 flows through the fifth flow path, the combustion gas 140 may pass through both the high pressure turbine 124 of the high pressure supercharger 106 and the low pressure turbine 118 of the low pressure supercharger 104. Therefore, combustion gas 140 that flows through the fifth flow path 144 may supply power to both the high pressure compressor 122 and the low pressure compressor 116.

In other embodiments, the combustion gas 140 may flow through the sixth flow path 146. The sixth flow path 146 may direct the combustion gas 140 to enter the high pressure turbine 124, but direct a portion of the combustion gas 140 to bypass the low pressure turbine 118 via a first wastegate valve 152. All of the combustion gas 140 may be directed to bypass the low pressure turbine 118, or a first portion of the combustion gas 140 may bypass the low pressure turbine 118 and a second portion of the combustion gas 140 may enter the low pressure turbine 118. When flowing through the sixth flow path 146, the combustion gas 140 may provide power for only the high pressure compressor 122. In other embodiments, the combustion gas 140 may provide power for both the high pressure compressor 122 and the low pressure compressor 116. Moreover, the first wastegate valve 152 may enable control of the pressure of the gas 110 exiting the low pressure compressor 116. For example, the more combustion gas 140 that bypasses the low pressure turbine 118, the less power may be supplied to the low pressure compressor 116, thereby decreasing the pressure of the gas 110 exiting the low pressure compressor 116.

The combustion gas 140 may be directed to flow through the seventh flow path 148 via a second wastegate valve 154. When flowing through the second wastegate valve 154, at least a portion of the combustion gas 140 may be directed to bypass both the high pressure turbine 124 and the low pressure turbine 118. Therefore, combustion gas 140 flowing through the seventh flow path 148 may provide less power to the high pressure compressor 122 or the low pressure compressor 116. Again, all of the combustion gas 140 or a portion of the combustion gas 140 may be directed to bypass the high pressure turbine 124 and the low pressure turbine 118 via the second wastegate valve 154.

In still further embodiments, the combustion gas 140 may flow through the eighth flow path 150. When directed to flow through the eighth flow path 150, at least a portion of the combustion gas 140 may bypass the high pressure turbine 124 via the third wastegate valve 156 and may enter the fifth flow path 144 at a point upstream of the low pressure turbine 118. Therefore, when flowing through the eighth flow path 150, the combustion gas 150 may provide power to the low pressure compressor 116, but not the high pressure compressor 118. As mentioned previously, all of the combustion gas 140, or a portion of the combustion gas 140, may be directed to bypass the high pressure turbine 124 via the third wastegate valve 156, which may enable control of the pressure of the gas 110 exiting the high pressure compressor 122. For example, the more combustion gas 140 that bypasses the high pressure turbine 124, the less power that may be supplied to the high pressure compressor 122, thereby decreasing the pressure of the gas 110 exiting the high pressure compressor 122.

In certain embodiments, after the combustion gas 140 exits the low pressure turbine 118, the high pressure turbine 124, and/or the combustion system 128, the combustion gas 140 may be exhausted to atmosphere 158. In other embodiments, the combustion gas 140 may be exhausted to a processing plant, a storage vessel, a transportation vessel, or any other suitable place for exhaust combustion gases.

It should be noted that the gas 110 and the combustion gas 140 may be directed to flow through the first flow path 130, the second flow path 132, the third flow path 134, the fourth flow path, 136, the fifth flow path 144, the sixth flow path 146, the seventh flow path 148, and the eighth flow path 150 (collectively “the flow paths”) via a system of bypass and wastegate valves (labeled “V” in FIG. 3) and piping segments. For instance, the ECU 25 may be coupled to one or more actuators that may control the opening and closing of the system of valves that enable the gas 110 or the combustion gas 140 to access one or more of the flow paths. Additionally, it should be noted that the gas 110 and the combustion gas 140 may flow through more than one of the flow paths at a time. For example, the gas may flow through any combination of the first flow path 130, the second flow path 132, the third flow path 134, and/or the fourth flow path 136. Similarly, the combustion gas 140 may flow through any combination of the fifth flow path 144, the sixth flow path 146, the seventh flow path 148, and/or the eighth flow path 150. In certain embodiments, the engine assembly 100 may include a throttle valve 160 which controls a flow rate of the gas 110 into the combustion system 128. Additionally, a fuel metering valve 162 may be included in the engine assembly 100. The fuel metering valve 162 may be configured to supply additional fuel 18 into the engine assembly 100. The supply of fuel 18 controlled by the fuel metering valve 162 may be in addition to fuel 18 already present in the gas 110. In other embodiments, the gas 110 may not include any fuel 18, in which case, the fuel 18 supplied by the fuel metering valve 162 mixes with the gas 110 in a mixer 164 prior to entering the combustion system 128. Although the illustrated embodiment of FIG. 3 shows the fuel metering valve 162 positioned upstream of the throttle valve 160, in other embodiments, the fuel metering valve 162 may be positioned downstream of the throttle valve 160.

Additionally, the engine assembly 100 may include one or more sensors (labeled “S” in FIG. 3) disposed along one or more of the flow paths. The sensors may monitor a temperature, a pressure, a flow rate, a density, a humidity, or another parameter of the gas 110, the combustion gas 140, and/or ambient air. As discussed previously, the sensors may include atmospheric and engine sensors, such as pressure sensors, temperature sensors, speed sensors, and so forth. For example, the sensors may include knock sensors, crankshaft sensors, oxygen or lambda sensors, engine air intake temperature sensors, engine air intake pressure sensors, jacket water temperature sensors, engine exhaust temperature sensors, engine exhaust pressure sensors, and exhaust gas composition sensors.

The engine assembly 100 of FIG. 3 may be configured to operate more efficiently by implementing a VVT profile to control opening and closing the intake valve 62 and/or the exhaust valve 64. In addition, the engine assembly 100 (e.g., via the ECU 25) may be configured to monitor and/or control various operating parameters (e.g., boost pressure, valve position, or the like) of the engine 10 to optimize efficiency.

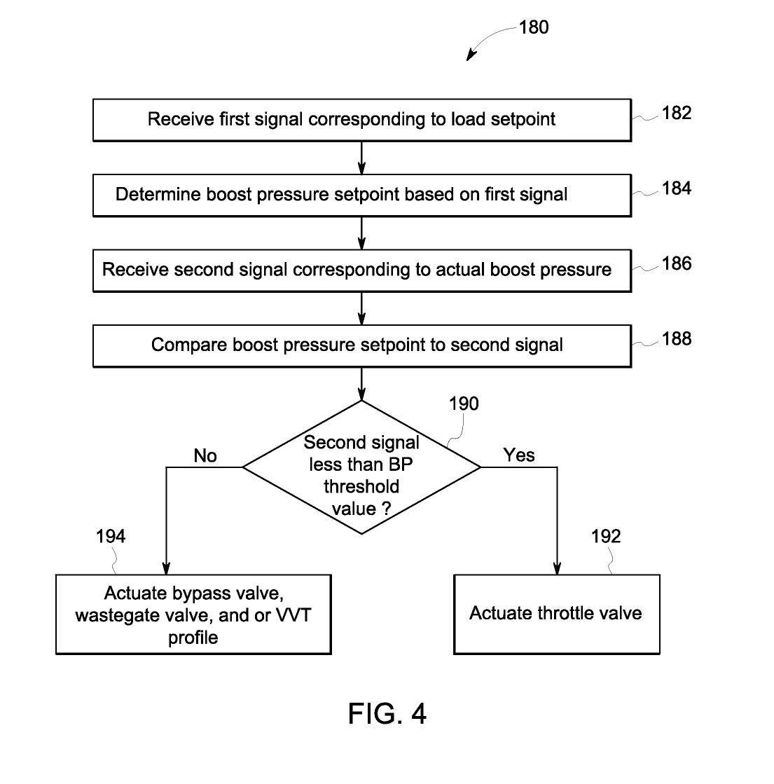

FIG. 4 illustrates an embodiment of a flow chart for a process 180 that may monitor and adjust a pressure (e.g., boost pressure) in the combustion system 128 supplied by the supercharger 104 and/or 106 to enhance the performance of the engine 10. In certain embodiments, all or some of the operations or steps illustrated in the process 180 may be performed by the processor 72 of the ECU 25. For example, the processor 72 may execute algorithmic instructions and/or process data stored in the memory 74. At block 182 the processor 72 may receive a first signal that corresponds to a setpoint for the engine load. For example, during transient engine operation, the engine 10 may experience an increase in load such that engine power and/or engine speed may increase to meet the demand. Similarly, the engine 10 may experience a decrease in load, thereby decreasing the engine speed so that an adequate amount of power is supplied to the load. Accordingly, at block 182, the processor 72 may receive the first signal from a user input indicating that an increase or decrease in load is demanded, or the first signal may be received from an electronic device (e.g., a sensor or another control unit) that determines (e.g., senses) a change in the amount of power demanded by the load.

At block 184, the processor 72 may utilize the first signal to determine a pressure (e.g., boost pressure) setpoint for the supercharger 102. The supercharger 102 may be a turbocharger, a supercharger, or any other device configured to supply pressure to the cylinder 26. The processor 72 may determine the boost pressure setpoint by utilizing the first signal corresponding to the engine load demand. For example, as the engine load demand increases the boost pressure setpoint may increase and the VVT profile may direct the intake valve 62 to be open for a longer period of time so that more oxidant 16 and fuel 18 are present within the cylinder 26. Similarly, as engine load demand decreases, the boost pressure setpoint may decrease and the VVT profile may direct the intake valve 62 to close sooner than under ordinary engine operation (e.g., under the Otto Cycle). At block 186, the processor 72 may receive a second signal that corresponds to the actual boost pressure of the supercharger 102. For example, a pressure sensor positioned in between the second intercooler 122 and the combustion system 128 may send a signal to the processor 72 that includes a pressure of the gases 110 entering the combustion system 128. In other embodiments, the pressure sensor may be located anywhere along first flow path 130, the second flow path 132, the third flow path 134, and/or the fourth flow path 136. In still other embodiments, the sensor may not be a pressure sensor, rather, the sensor include any sensor that monitors a parameter indicative of the boost pressure.

At block 188, the processor 72 may be configured to compare the boost pressure setpoint determined at block 184 to the actual boost pressure from the second signal. The processor 72 may include or execute programming stored in the memory device 74 that compares the value of the boost pressure setpoint and the actual boost pressure. In certain embodiments, the actual boost pressure and the boost pressure setpoint may be converted by the processor 72, such that the processor 72 may compare equivalent values (e.g., when the boost pressure setpoint and actual boost pressure are in different units). In certain embodiments, the processor 72 may make adjustments to valves in the engine 10 such that the actual boost pressure equals the boost pressure setpoint.

At block 190, the processor 72 may cause (e.g., adjust various operating conditions of the engine 10) the actual boost pressure to be altered so that it may be as close to the boost pressure setpoint as possible. In certain embodiments, the action in which the processor 72 takes may depend on the comparison of a threshold boost pressure value to the actual boost pressure performed at block 188. For example, at block 192, when the processor 72 determines that the actual boost pressure is less than the threshold boost pressure value, the processor 72 may send a signal to an actuator coupled to the throttle valve 160 (e.g., a valve disposed upstream of the combustion system 128 that controls a flow rate of gas 110 into the combustion system 128) to adjust a position of the throttle valve 160. In certain embodiments, the processor 72 may command the actuator to open the throttle valve 160 when the actual boost pressure is below the threshold boost pressure value in order to increase the fuel 18 and/or oxidant 16 present in the cylinder 26, thereby increasing power output of the engine 10.

At block 194, when the processor 72 determines that the actual boost pressure is greater than or equal to the threshold boost pressure value, the processor 72 may send a signal to one or more actuators coupled to the bypass valves 137, 138, and/or 139 or the wastegate valves 152, 154, and/or 156. Similarly, the processor 72 may adjust a VVT profile of the intake valve 62 such that that the closure timing of the intake valve 62 may occur at a more optimal time. In certain embodiments, when the processor 72 adjusts the bypass valves 137, 138, and/or 139 and/or the wastegate valves 152, 154, and/or 156 (e.g., via one or more actuators) the actual boost pressure in the engine assembly 100 may change. For example, when the actual boost pressure is higher than the threshold boost pressure value, the processor 72 may send a signal to open one or more of the bypass valves 137, 138, and 139, such that less gas 110 enters the intake manifold 141, thereby decreasing the actual boost pressure so that it approaches the boost pressure setpoint. Similarly, the processor 72 may send a signal to open one or more of the wastegate valves 152, 154, and 156 such that less combustion gas 140 enters the high pressure turbine 124 and/or the low pressure turbine 118, thereby decreasing an amount of power supplied to the high pressure compressor 122 and/or the low pressure compressor 116, respectively. Further, the processor 72 may also adjust the VVT profile so that the intake valve 62 stays open for a more optimal time. For example, when the load demand increases and the actual boost pressure is greater than the threshold boost pressure value, the intake valve 62 (or the throttle valve 160) may close earlier than in a traditional Miller Cycle to avoid excess pressure in the cylinder 26. In certain embodiments, the processor 72 may send simultaneous signals to the bypass valves 137, 138, and 139; the wastegate valves 152, 154, and 156; as well as to the VVT device storing the VVT profile.

In certain embodiments, the process 180 may repeat these steps (e.g., go from block 192 or 194 back to block 182) until the actual boost pressure equals the boost pressure setpoint. In such a case, the desired engine load has been achieved such that no more adjustments are necessary until another change in engine load occurs.

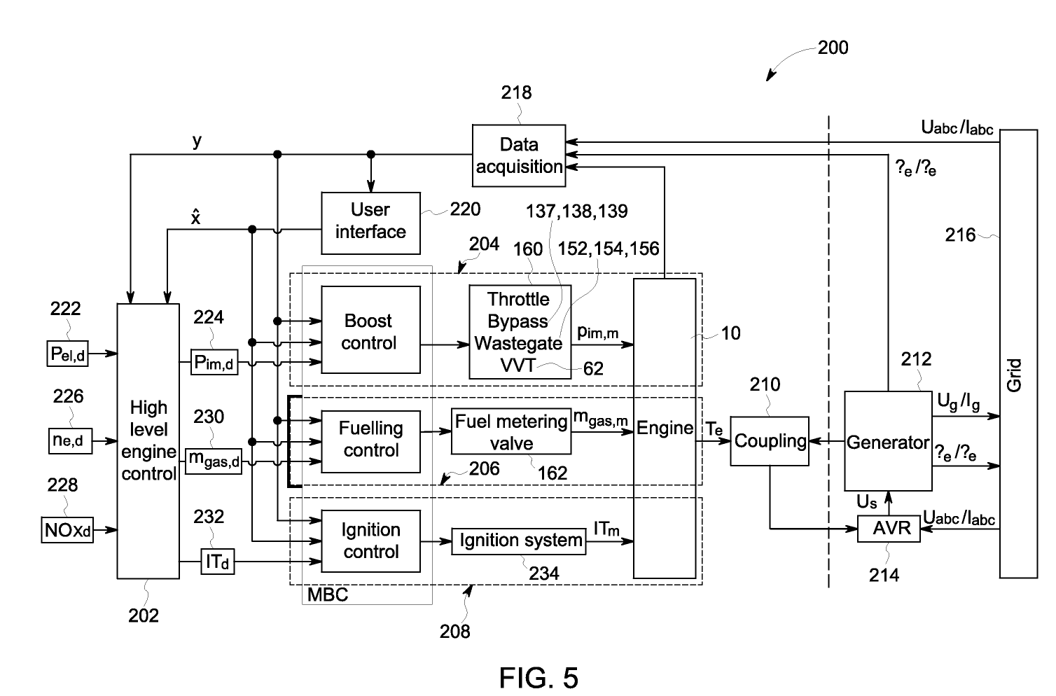

FIG. 5 illustrates a block diagram of a power supply system 200 that may utilize the process 180 described in FIG. 4. As illustrated, the power supply system 200 includes a high level engine control 202, a boost control module 204, a fuelling control module 206, an ignition control module 208, the engine 10, coupling 210, a generator 212, an automatic voltage regulator 214, a power grid 216, a data acquisition module 218, and a user interface 220.

The boost control module 204, the fuelling control module 206, and the ignition control module 208 may be configured to monitor and adjust various operating parameters of the power supply system 200 and/or the engine 10 to enhance efficiency of the system 200. The engine 10 may supply power to the generator 212, which may power the grid 216. The engine 10 and generator 212 may be connected via the coupling 210. The coupling 210 may include a device configured to join a shaft of the engine 10 and a shaft connected to the generator 212. The coupling 210 may be sleeve coupling, flange coupling, clamp coupling, bush pin type flange coupling, beam coupling, diaphragm coupling, disc coupling, fluid coupling, gear coupling, grid coupling, Oldham coupling, rag joint coupling, or any other device configured to connect the engine 10 to the generator 212.

The high level engine control 202, the boost control module 204, the fuelling control module 206, the ignition control module 208, or any combination thereof, may be programmed to perform the process 180 described in detail with reference to FIG. 4 (e.g., via the processor 72). In certain embodiments, the high level engine control 202 may include the ECU 25. As described in the process 180, the high level engine control 202 may monitor and adjust the actual boost pressure within the engine assembly 100 by determining a boost pressure setpoint based on the load demand of the engine. For example, the high level engine control 202 may receive a first signal 222 related to a desired electrical power. The desired electrical power may be based off a power demand for the power grid 216. In certain embodiments, the power demand may be estimated by a power company. In other embodiments, the power demand may be measured based on a current demand of power by the grid 216 (e.g., via a sensor). The high level engine control 202 may output a second signal 224 to the boost control module 204 related to a desired intake manifold pressure (e.g., the boost pressure setpoint). The boost control module 204 may adjust the throttle valve 160, one of the bypass valves 137, 138, and/or 139, one of the wategate valves 152, 154, and/or 156, and/or the VVT profile to alter the actual boost pressure in accordance with the process 180.

The high level engine control 202 may also monitor and adjust a flow rate of fuel 18 supplied to the engine via the fuelling control module 206. For example, in addition to receiving the first signal 222, the high level engine control 202 may receive a third signal 226 related to a fuel quality or an engine speed demand and/or a fourth signal 228 corresponding to an emissions setpoint. In certain embodiments, the fuel quality may be quantified using the Methane Number (MN), the Waukesha Knock Index (WKI), or the concentration of various fuel gas components (e.g., carbon dioxide, carbon monoxide, and/or hydrogen). The engine speed demand may be quantified in revolutions per minute (RPM) and based on the power demand (e.g., the first signal 222). Similarly, the emissions setpoint may be determined based on an environmental regulation that places a restraint on how much nitrogen oxide (NOx) may be emitted into the atmosphere within a given time period (e.g., per day), or the emissions setpoint may be determined based on actual NOx emissions. Accordingly, the high level engine control 202 may compute a desired mass flow rate of fuel 18 to enter the engine 10 based at least on the first signal 222, the third signal 226, and/or the fourth signal 228. The high level engine control 202 may then send a fifth signal 230 to the fuelling control module 206, which may adjust a position of the fuel metering valve (e.g., TecJet) 162 in response to the fifth signal 230. The fuelling control module 206 may receive feedback and/or the desired mass flow rate of fuel 18 from the data acquisition module 218 and/or the user interface 220.

The high level engine control 202 may monitor and adjust an ignition timing of the engine 10 via the ignition control module 206. Again, the high level engine control 202, may receive the first signal 222, the third signal 226, and/or the fourth signal 228. The high level engine control 202 may include an ignition timing map programmed and stored within a memory component (e.g., the memory component 74) that may be used to determine a desired ignition timing setpoint. The high level engine control 202 may then send a sixth signal 232 corresponding to the desired ignition timing. The ignition control module 206 may adjust the timing (e.g., crank angle) in which a spark is introduced into the cylinder 26 based at least on the sixth signal 232. In certain embodiments, the ignition control module 206 may be adjusted using an ignition system (e.g., SAFI) 234.

It should be noted that the control system 200 may operate the boost control module 204, the fuelling control module 206, and/or the ignition control module 208 separately, or at the same time, to optimize engine performance.

In certain embodiments, one or more sensors, collectively the data acquisition module 218, may be disposed in the power supply system 200. The data acquisition module 218 may collect operating parameters of the power supply system 200 and send signals (e.g., feedback) to the high level engine control 202, the boost control module 204, the fuelling control module 206, and/or the ignition control module 208. The data acquisition module 218 may monitor a temperature, a pressure, a flow rate, a density, a humidity, or another parameter of the power supply system 200. As discussed previously, the sensors of the data acquisition module 218 may include atmospheric and engine sensors, such as pressure sensors, temperature sensors, speed sensors, and so forth. For example, the sensors may include knock sensors, crankshaft sensors, oxygen or lambda sensors, engine air intake temperature sensors, engine air intake pressure sensors, jacket water temperature sensors, engine exhaust temperature sensors, engine exhaust pressure sensors, and exhaust gas composition sensors. Similarly, the power supply system 200 may include a user interface 220. The user interface 220 may enable a human operator to input setpoints and other information that the boost control module 204, the fuelling control module 206, and/or the ignition control module 208 may utilize when making adjustments to the various operating parameters.

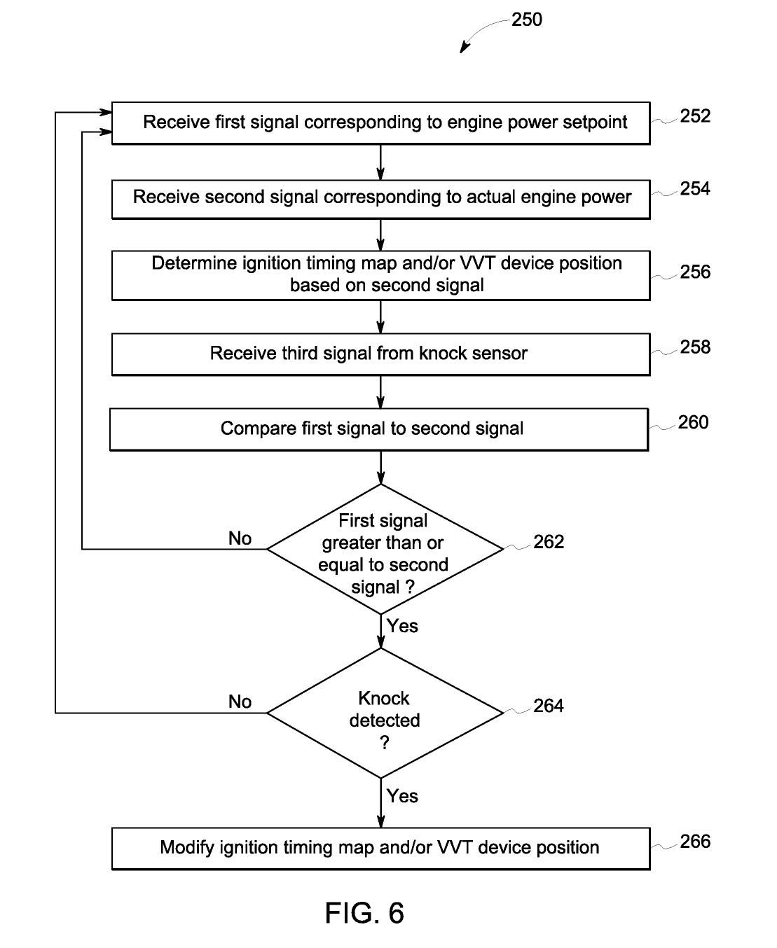

FIG. 6 illustrates another embodiment of a process 250 in accordance with the present disclosure. The process 250 may be configured to modify an ignition timing map and/or a VVT profile based on engine power and whether an engine knock event has been detected. As mentioned above, engine knock may refer to combustion at an unexpected time not during a normal window of time for combustion. In certain embodiments, all or some of the operations or steps illustrated in the process 250 may be performed by the processor 72 of the ECU 25. For example, the processor 72 may execute algorithmic instructions and/or process data stored in the memory 74. At block 252 the processor 72 may receive a first signal that corresponds to a setpoint for a desired engine power to provide to a load. For example, during transient engine operation, the engine 10 may experience an increase in load such that engine power and/or engine speed may increase to meet the demand. Similarly, the engine 10 may experience a decrease in load, such that the engine power supplied to the load may decrease to reach the demanded power level. Accordingly, at block 252, the processor 72 may receive the first signal from a user input (e.g., via the user interface 220) indicating that an increase or decrease in load is demanded. In other embodiments, the first signal may be received from an electronic device (e.g., sensor or another control unit) that includes information regarding a change in the amount of power demanded by the load.

At block 254, the processor 72 may utilize the first signal to determine an ignition timing from an ignition timing map and/or determine a timing of a VVT device (e.g., timing related to closing the intake valve 62) from a VVT profile. An ignition timing map may relate to a set of data that provides an ignition timing value that corresponds to an engine speed and/or load, among other factors. The ignition timing values in the engine timing map, however, depend on the engine operating conditions, such as fuel quality, fuel temperature, fuel pressure, air temperature, engine temperature, and intake air pressure. Therefore, the ignition timing map may be determined based on measured operating parameters of the engine (e.g., load or engine power) and updated accordingly to enhance engine performance. Similarly, VVT profiles (e.g., timing values that determine when to open and close the intake valve 62) may be pre-determined and thus may not take into account all operating parameters that affect engine performance. Therefore, it may be desirable to adjust VVT profiles in addition to other engine control modules to enhance the response time of an engine during transient operation.

At block 254, the processor 72 may receive a second signal that corresponds to the actual engine power output. For example, a load sensor may send a signal to the processor 72 that includes a value corresponding to the load demand. Additionally, a sensor measuring the speed of the engine (e.g., a tachometer, a Hall Effects Sensor, or any other sensor configured to measure engine speed) may send the second signal to the processor 72.

At block 256, the processor 72 may determine the ignition timing and/or the timing of the VVT device (e.g., the intake valve 62) by utilizing the first signal corresponding to the engine load demand. For example, as the engine load demand increases, the ignition timing (e.g., measured in crank angle) may be decreased so that the combustion occurs later and a temperature of the combustion gas 140 decreases Accordingly, more energy may be generated in the turbines 118, 124, and thus more power may be supplied to the compressors 116, 122. Similarly, the timing of the VVT device (e.g., the intake valve 62) may be adjusted so that the intake valve 62, for example, is open for a longer period of time upon an increase in engine load demand. As engine load demand decreases, the exhaust gas temperature decreases. Accordingly, less energy is generated in the turbines 118, 124, and thus, less power is transferred to the compressors 116, 122. Similarly, the timing of the VVT device (e.g., the intake valve 62) may be modified so that the intake valve 62, for example, closes earlier.

At block 258, the processor 72 may receive a third signal from the knock sensor 23. As discussed previously, the knock sensor 23 may be utilized to detect an engine knock event. The knock sensor 23 may include an acoustic or sound sensor, a vibration sensor, or a combination thereof. For example, the knock sensor 23 may include a piezoelectric accelerometer, a microelectromechanical system (MEMS) sensor, a Hall effect sensor, a magnetostrictive sensor, and/or any other sensor designed to sense vibration, acceleration, acoustics, sound, and/or movement. In other embodiments, the sensor 23 may not be a knock sensor, but any sensor that may sense vibration, pressure, acceleration, deflection, or movement. The knock sensor 23 may monitor acoustics and/or vibration associated with combustion in the engine 10 to detect a knock condition, e.g., combustion at an unexpected time not during a normal window of time for combustion. In certain embodiments, the knock sensor 23 sends the processor 72 a knock signal as the third signal. The knock signal may include a vibration, acoustic, sound, and/or movement profile corresponding to events within the engine cylinder. The knock signal may include an engine knock event, or conversely, the knock signal may not include an engine knock event. In certain embodiments, the processor 72 may be configured to analyze the knock signal and determine whether an engine knock event is present within the knock signal. In other embodiments, such an analysis may be performed prior to the processor 72 receiving the knock signal.

At block 260, the processor 72 may be configured to compare the first signal from block 252 to the second signal from block 256. The processor 72 may include or execute programming stored in the memory device 74 that compares the values of the two signals. In certain embodiments, the processor may make adjustments to various components of the engine 10 such that the value of the second signal is as close to the value of the first signal as possible.

At block 262, the processor 72 may cause (e.g., adjust various operating conditions of the engine 10) the ignition timing map and/or the VVT profile to be altered so that the actual engine power may be as close to the engine power set point as possible. In certain embodiments, the action in which the processor 72 takes may depend on the comparison of the first signal to the second signal performed at block 260. Therefore, at block 262, the processor 72 may determine whether the first signal is greater than or equal to the second signal. Additionally or alternatively, the processor 72 may determine whether an engine knock event occurred at block 264.

When the processor 72 determines that the actual engine power is less than the engine power setpoint and that an engine knock event occurred, the processor 72 may modify the ignition timing map and/or the VVT profile, at block 266. In other embodiments, the processor 72 may send a signal to another computing device (e.g., a controller, the ECU 25, or another electronic computing device) instructing the device to modify the ignition timing map and/or the VVT profile. The processor 72 may modify the ignition timing map and/or the VVT profile when the actual engine power is less than the engine power setpoint because the engine has not met the demanded load and an engine knock event resulted. Therefore, adjustments to the engine assembly 100 may be performed in order to enable the engine to reach the demanded load more quickly and prevent engine knocking.

Conversely, if the actual engine power is greater than or equal to the engine power setpoint, and/or if no engine knock event occurred, the processor 72 may take no action and simply repeat the steps in blocks 252 to 264. In certain embodiments, the process 250 may repeat these steps (e.g., go from block 262, 264, and/or 266 back to block 252) until the actual engine power equals the engine power setpoint. In such a case, the desired engine load has been achieved such that no more adjustments are necessary.

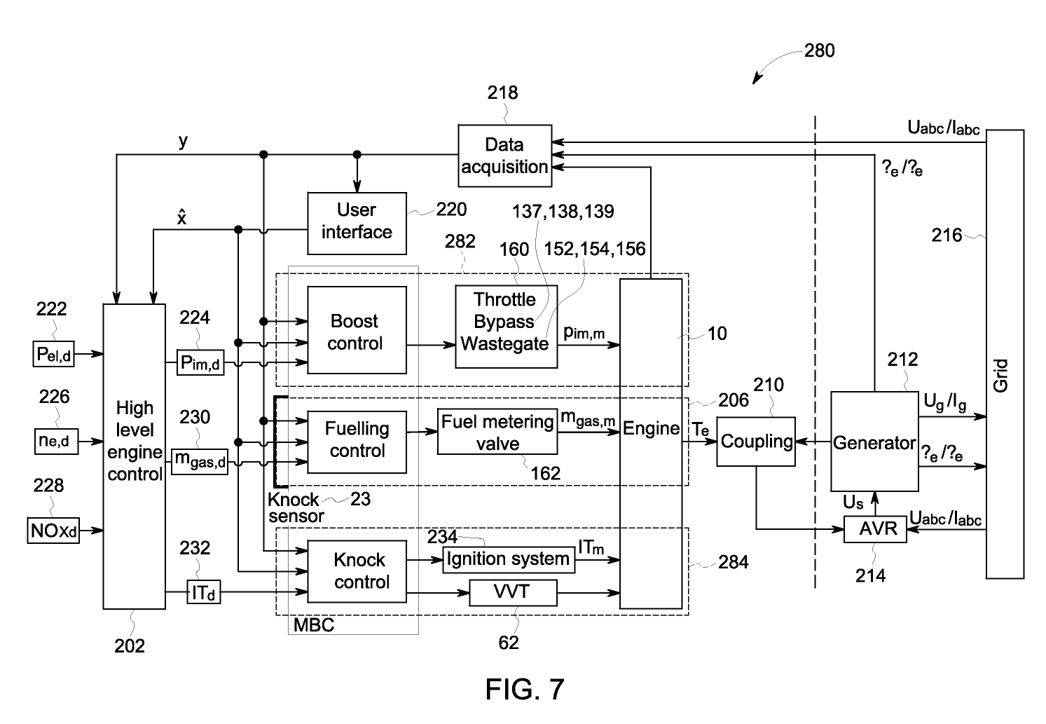

FIG. 7 illustrates a block diagram of another embodiment of a power supply system 280 that may utilize the process 250 described in FIG. 6. As illustrated, the power supply system 280 includes the high level engine control 202, a boost control module 282, the fuelling control module 206, a knock control module 284, the engine 10, the coupling 210, the generator 212, the automatic voltage regulator 214, the power grid 216, the data acquisition module 218, and the user interface 220.

The boost control module 282, the fuelling control module 206, and the knock control module 284 may be configured to monitor and adjust various operating parameters of the power supply system 280 and/or the engine 10 to enhance efficiency of the system 280.

The high level engine control 202, the boost control module 282, the fuelling control module 206, the knock control module 284, or any combination thereof, may be programmed to perform the process 250 described in detail with reference to FIG. 6 (e.g., via the processor 72). As described in the process 250, the high level engine control 202 may monitor and adjust the actual boost pressure within the engine assembly 100 by determining a boost pressure setpoint based on the load demand of the engine. For example, the high level engine control 202 may receive a first signal 222 related to a desired electrical power. The desired electrical power may be based off a power demand for the power grid 216. In certain embodiments, the power demand may be estimated by a power company. In other embodiments, the power demand may be measured based on a current amount of power demanded by the grid 216 (e.g., via a sensor). The high level engine control 202 may output a second signal 224 to the boost control module 204 related to a desired intake manifold pressure (e.g., the boost pressure setpoint). The boost control module 204 may adjust the throttle valve 160, one of the bypass valves 137, 138, and/or 139, and/or one of the wategate valves 152, 154, and/or 156, to alter the actual boost pressure in accordance with the process 180. The boost control module 282 of the system 280 is different from the boost control module 204 of the system 200 because it does not adjust a VVT profile (e.g., the intake valve 62). In other embodiments, however, the boost control module 282 may adjust the VVT profile.

The high level engine control 202 may also monitor and adjust a flow rate of fuel 18 supplied to the engine via the fuelling control module 206. For example, in addition to receiving the first signal 222, the high level engine control 202 may receive a third signal 226 related to a fuel quality and/or an engine speed demand and/or a fourth signal 228 corresponding to an emissions setpoint. Accordingly, the high level engine control 202 may compute a desired mass flow rate of fuel 18 to enter the engine 10 based at least on the first signal 222, the third signal 226, and/or the fourth signal 228. The high level engine control 202 may then send a fifth signal 230 to the fuelling control module 206, which may adjust a position of the fuel metering valve (e.g., TecJet) 162 in response to the fifth signal 230. The fuelling control module 206 may receive feedback and/or the desired mass flow rate of fuel 18 from the data acquisition module 218 and/or the user interface 220.

The high level engine control 202 may monitor and adjust an ignition timing of the engine 10 via the knock control module 284. Again, the high level engine control 202, may receive the first signal 222 the third signal 226, and/or the fourth signal 228. The high level engine control 202 may include an ignition timing map programmed and stored within a memory component (e.g., the memory component 74) that may be used to determine a desired ignition timing setpoint. The high level engine control 202 may then send a sixth signal 232 to the knock control module 206, which may adjust the timing (e.g., crank angle) in which a spark is introduced into the cylinder 26 based at least on the sixth signal 232. In certain embodiments, the knock control module 206 may be adjusted using the ignition system (e.g., SAFI) 234. Further, the knock control module 284 may also include the knock sensor 23. As described above, the knock sensor 23 may monitor acoustics and/or vibration associated with combustion in the engine 10 to detect a knock condition, e.g., combustion at an unexpected time not during a normal window of time for combustion. Therefore, the knock control module 284 may adjust the ignition timing based on the first signal 222, the third signal 226, the fourth signal 228, and/or a seventh signal received from the knock sensor 23. Moreover, the knock control module 284 may also be configured to adjust a timing of a VVT device (e.g., the intake valve 62) and/or the VVT profile in response to the first signal 222, the third signal 226, the fourth signal 228, and/or the seventh signal. As described in detail with reference to FIG. 6, the timing of the VVT device and/or the VVT profile may be adjusted in order to prevent engine knock and enhance the efficiency of the engine 10.

It should be noted that the control system 200 may operate the boost control module 282, the fuelling control module 206, and/or the knock control module 284 separately, or at the same time, to optimize engine performance. Additionally, the power supply system 280 may also include the acquisition module 218 and/or the user interface 220.

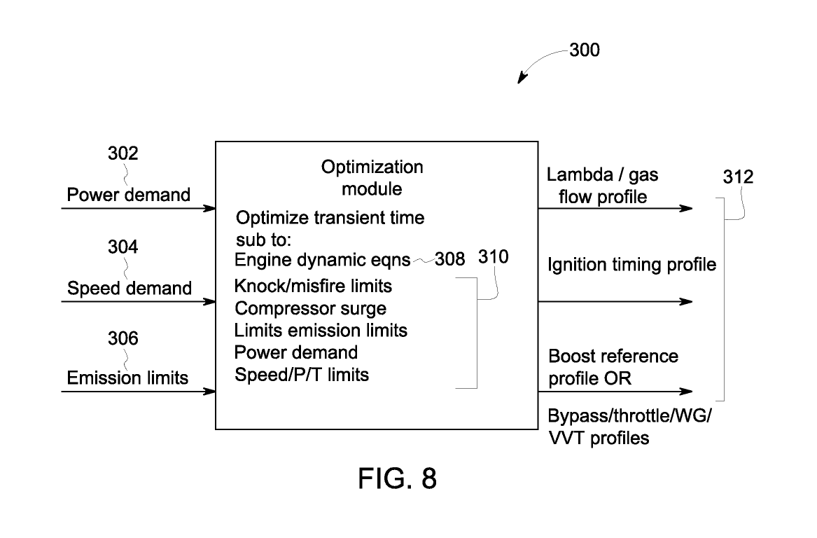

FIG. 8 illustrates an optimization module 300 in accordance with aspects of the present disclosure. The optimization module 300 receives one or more inputs (e.g., the first signal 222, the third signal 226, the fourth signal 228) that provide the module 300 with information that enables the module 300 to optimize engine performance. In the illustrated embodiment, the optimization module 300 has three inputs (e.g., operational conditions): power demand 302, speed demand 304, and emission limits 306. In certain embodiments, the optimization module 300 may receive all three inputs, or it may receive any combination of the three inputs 302, 304, and 306. In other embodiments, the optimization module 300 may receive less than three inputs (e.g., 1 or 2) or the module 300 may receive more than three inputs (e.g., 4, 5, 6, 7, 8, 9, 10, 12, 15, 20, 25, 30 or more). The inputs to the optimization module 300 may be referred to as operational conditions. As used herein, operational conditions may be a user input or electronic signal relating to a desired value of an operating parameter. For example, an operational condition may be the power demand 302, the speed demand 304, and/or the emissions limit 306 specified by a user or determined by a computing device.

The optimization module 300 may utilize the operational conditions and perform calculations and/or other data manipulation techniques to make determinations regarding the enhancement of engine performance. For example, the optimization module may apply engine dynamic equations 308 to the operational conditions 302, 304, and/or 306. Additionally, the module 300 may utilize operational constraints 310 such as knock or misfire limits, compressor surge limits, emission limits, power demand limits, speed limits, or the like. An operating constraint 310, as used herein, may refer to a maximum value of an operating parameter. For example, values of operating parameters that may not be exceeded without engine knock or engine misfire occurring.

The optimization module 300 may create an operational profile 312 and/or modify an existing operational profile 312 at least based on the calculations performed using the operational conditions and/or the operational constraints. Operational profiles 312 may be sets of data, formulae, or pre-determined values that the module 300 applies when a specific set of operating conditions is present. Operational profiles may include lambda/gas flow profile, ignition timing profile, boost reference profile, bypass valve profile, throttle valve profile, wastegate valve profile, and/or VVT profile.

By modifying and/or creating the new profiles based on the operational conditions and/or the operational constraints 310, the optimization module 300 may be able to take into consideration a great deal of factors (e.g., from the data acquisition module 218 and/or other sensors) and make adjustments to a plurality of components of the engine 10 to enhance the engine 10 performance. Such an optimization model may enable an engine to reach a desired engine speed or desired load more quickly when undergoing transient operation (e.g., increase in load, decrease in load, etc.).

Technical effects of the invention include utilizing a VVT device and adjusting the VVT profile in combination with another engine module (e.g., ignition timing module, boost control module, fuelling control module) so that the engine 10 can respond more quickly to a change in load demand. Such a system may enable enhanced engine operation.

This written description uses examples for the subject disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What we claim is:

1. A system for controlling transient operations of an engine, comprising:
a controller configured to:
receive a first signal corresponding to a load setpoint of the engine;
determine a boost pressure setpoint based at least on the first signal;
receive a second signal corresponding to an actual boost pressure in the engine;
compare the second signal to the boost pressure setpoint;
actuate or modify one or more of a bypass valve, a wastegate valve, a throttle valve, and a variable valve timing profile when the second signal is greater than or equal to a boost pressure threshold value; and
actuate the throttle valve when the second signal is less than the boost pressure threshold value.

2. The system of claim 1, wherein the second signal is sent from a sensor configured to monitor a pressure of fluid exiting a supercharger.

3. The system of claim 2, wherein the supercharger comprises a compressor and a turbine.

4. The system of claim 1, wherein the second signal is sent from a sensor configured to monitor a pressure of fluid exiting an intake manifold.

5. The system of claim 1, wherein the first signal is sent from a load sensor, a sensor configured to sense engine speed, or any other sensor configured to detect a load demand of the engine.

6. The system of claim 1, wherein the controller is configured receive a third signal and to compute one or more of a degree of actuation or modification for the bypass valve, the wastegate valve, and the variable valve timing profile based at least on the third signal.

7. The system of claim 6, wherein the third signal comprises a quality of fuel entering the engine, an ambient pressure, an ambient temperature, an ambient humidity, or any combination thereof.

8. A system for controlling transient operations of an engine comprising:
a controller configured to:
receive a first signal corresponding to an engine power setpoint of the engine;
receive a second signal corresponding to an actual engine power of the engine;
determine an ignition timing and a position of a variable valve timing device based at least on the second signal;
receive a third signal from a knock sensor;
compare the first signal to the second signal; and
modify one or more of a variable valve timing profile and an ignition timing map when the first signal is greater than the second signal and when the third signal indicates an engine knock event.

9. The system of claim 8, wherein the controller is configured to receive a fourth signal and to compute one or more of a degree of modification of the variable valve timing profile and the ignition timing map based at least on the fourth signal.

10. The system of claim 9, wherein the fourth signal comprises a quality of fuel entering the engine, an ambient pressure, an ambient temperature, an ambient humidity, or any combination thereof.

11. The method of claim 8, wherein the knock sensor is a piezoelectric accelerometer, a microelectromechanical system sensor, a Hall effect sensor, a magnetostrictive sensor, and/or any other sensor designed to sense vibration, acceleration, acoustics, sound, and/or movement.

12. The system of claim 9, wherein the variable valve timing device comprises an intake valve or a throttle valve.

13. A system for controlling transient operations of an engine, comprising:
a sensor configured to monitor an engine demand;
an actuator coupled to one or more valves; and
a controller configured to:
receive a signal from the sensor corresponding to the engine demand;
determine an operational profile of the one or more valves based on the signal, an operational condition, and an operational constraint; and
send a signal to the actuator to adjust the one or more valves according to the operational profile to satisfy the operational condition and the operational constraint.

14. The system of claim 13, wherein the one or more valves comprise one or more of a throttle valve, a compressor bypass valve, a fuel metering valve, a wastegas valve, and an intake valve.

15. The system of claim 13, wherein the sensor comprises one or more of a pressure sensor, a temperature sensor, a humidity sensor, and a knock sensor.

16. The system of claim 13, wherein the controller comprises a boost control sub-controller that is configured to:
determine pressure demand for a throttle valve based on the engine demand;
actuate the throttle valve when the engine demand is less than a first threshold; and
actuate one or more of a bypass valve, a wastegate valve, and a variable valve timing device when the engine demand is greater than or equal to the first threshold.

17. The system of claim 13, comprising a knock sensor, and wherein the controller is configured to:
determine an engine knock event based on a signal received from the knock sensor;
determine an expected ignition timing based on the engine demand;
actuate an intake valve when the engine load is greater than or equal to a first threshold and the signal corresponds to an engine knocking event; and
determine a new ignition timing.

18. The system of claim 13, wherein the operational profile comprises a lambda/gas flow profile, an ignition timing profile, a boost pressure profile, a bypass valve closure profile, a throttle valve closure profile, a wastegate valve closure provile, and/or a variable valve timing profile.

19. The system of claim 13, wherein the operational constraint comprises a knock limit, a misfire limit, a compressor surge limit, an emission limit, a power demand, an engine speed limit, a pressure limit, a temperature limit, or any combination thereof.

20. The system of claim 13, wherein the operational condition comprises an engine load setpoint, an engine speed setpiont, an engine power setpoint, a boost pressure setpoint, or any combination thereof.
